(19) United States
(12) Patent Application Publication
(10) Pub. No.: US 2007/0168389 A1
(43) Pub. Date: Jul. 19, 2007

(54) Systems and methods for presenting customized information

(76) Inventor: Kenneth O. Lipscomb, Marietta, GA (US)

Correspondence Address: NORA M. TOCUPS, P.O BOX 698, 140 PINECREST AVE, DECATUR, GA, 30030, US

(21) Appl. No.: 11/326,088

(22) Filed: Jan. 4, 2006

(51) Int. Cl. G06F 17/00

(52) U.S. Cl. 707/104.1

(57) ABSTRACT

Systems and methods for presenting customized information to a user recognized when making a request for information. Target information for the user is identified based on the user's profile, the requested information, and/or other factors. The customized information is assembled by causing association of the target information with requested information. The association may include insertion of the target information into an insertion point of the requested information such as between two sequential parts of the requested information, at a marker, based on a time code or an event code. Target information may include a first and second target. The requested information may be received in parts from one or more sources. The first and second target may be associated respectively with parts of the requested information. Target information for the user may be stored. A computer readable medium may include computer executable instructions for carrying out the described actions.

### FIELD OF THE INVENTIONS

The inventions relate to communications, and in particular, to the quick and accurate provision of tailored information as part of other information in a communications network.

### BACKGROUND

Advertisers hate wasting money. Paying for advertising that is ignored or irrelevant to the consumers watching an advertising-subsidized presentation is wasted money. Waste, however, has been typically inevitable because there has been no sure way for determining exactly who is watching any particular presentation at any particular time. Without knowing who is watching, advertisers do not know what kind of advertising to present to maximize the effect of the advertising. Organizations such as Nielsen Media Research and Arbitron may conduct polls, but such polling does not necessarily reveal exactly who is watching a particular presentation and at what time.

What if an advertiser could determine who is watching a particular presentation? The mere identity of a watcher generally does not provide the advertiser with enough information to maximize its advertising dollars. Rather, typically advertisers have had to be satisfied with presenting ads that are most likely to appeal to or at least be watched by presentation watchers. For example, if the presentation is a sporting event, ads hyping the particular equipment of the sporting event may be presented. These ads for sporting goods are generally wasted on couch-potatoes and others uninterested in actual participation in the sport.

What if an advertiser could know the interests of a specific person watching a particular presentation? Knowing a specific watcher's interests does not always allow the advertiser to present the perfect advertisements. Time is an issue. By the time an advertiser is informed of a particular watcher's or even a group's interest in a particular topic, it may be impossible to get the right advertisement timely broadcast during the relevant event. By the time information on a watcher's specific interests makes its way to the people who cause the ads to be shown, the presentation may be long over.

The problems in the prior art have been discussed above generally in the context of a user watching a presentation, but the same issues relate to users of media players of all types.

Accordingly, there is a need for a way to determine who is making use of media such as by listening and/or viewing, what kind of use is being made, what time and for how long the use is being made, and what interests, or other factors are associated with the user.

### SUMMARY

Stated generally, the inventions relate to methods and systems for presenting customized information to a user. For example, a consumer using a media player may be presented with an advertisement specially targeted to that particular user while he or she is watching a movie, listening to music, playing a game, or is otherwise engaged.

Advantageously, the inventions provide a way to determine who is making use of media, what kind of use is being made, what time and for how long the use is being made, and what interests, or other factors are associated with the user.

An exemplary embodiment of the inventions recognizes a user when he or she makes a request for information. Based on the recognition, target information for the user is identified. The target information may be identified based on a profile of the user, based on the information requested by the user, and/or based on other factors. The target information is assembled with the requested information into the customized information and presented to the user.

Target information for a user may include a first target and a second target. When the customized information is assembled, the first target may be associated with a first part or element of the requested information while the second target is associated with a second part or element.

Assembly of the customized information may include insertion of the target information into an insertion point of the requested information. The requested information may be made up of parts received from two or more sources. An insertion point of the requested information may be a point between two parts of the requested information, and specifically, may be a point between two sequential parts of the requested information. An insertion point also may be a marker embedded in the presentation. In addition, an insertion point in requested information may be determined based on a time code, and/or an event code.

Target information for a user may be stored on a media device of the user or may be obtained from other sources. Identifying target information may include determining locations of a respective part or parts constituting the target information. Assembling the customized information in that case may include obtaining or causing the obtaining of the respective part or parts constituting the target information, and causing the association of the target information with the requested information.

The inventions also may allow for an exemplary embodiment that causes presentation of additional information targeted to a first user when the first user requests information, and presentation of additional information targeted to a second user when the second user requests the information. In this example, target information may be stored for each of the users. When a request for information is made, determination is made if the first user or the second user requested the information. If the first user requested the information, target information for the first user is determined. If the second user requested the information, target information for the second user is determined. Target information for the first user is inserted at an insertion point of the requested information if the first user requested the information, or target information for the second user is inserted, if the second user is requesting the information.

The advantages of the inventions may be more clearly understood and appreciated from a review of the following detailed description and by reference to the appended drawings and claims.

### BRIEF DESCRIPTION OF THE DRAWINGS

FIG. 1 is a flow diagram providing an overview of an exemplary embodiment of the inventions.

FIG. 2 shows a sample environment that may be used with an exemplary embodiment of the inventions.

FIGS. 3A and 3B are illustrate representational requested information without target information and with inserted exemplary target information.

### DETAILED DESCRIPTION

The inventions are described herein with reference to exemplary embodiments, alternative embodiments and also with reference to the attached drawings. The inventions, however, can be embodied in many different forms and carried out in a variety of ways, and should not be construed as limited to the embodiments set forth in this description and/or the drawings. The exemplary embodiments described and shown herein are only some of the ways in which to implement the inventions. Elements and/or actions of the inventions may be assembled, connected, configured, and/or taken in an order different in whole or in part from the descriptions herein.

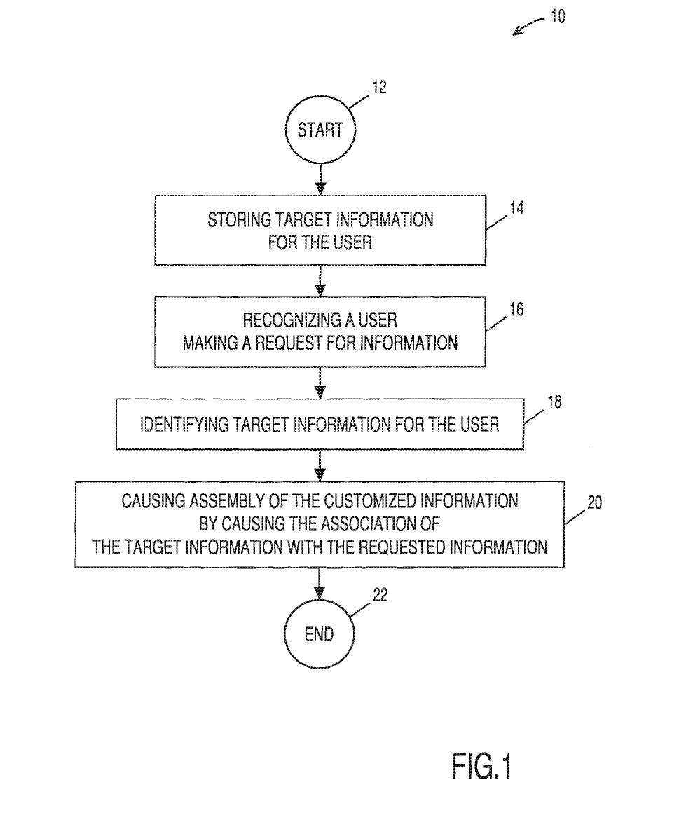

Reference is made to FIG. 1 to provide an overview of the inventions. FIG. 1 is a flowchart 10 of actions that may be taken by an exemplary embodiment of the inventions. After start 12, the exemplary embodiment may store target information relating to a user 14. For example, target information may include advertisements specifically tailored to the user 14. In action 16, the exemplary embodiment recognizes the user when he or she makes a request for information. For example, a user may order a movie for viewing, and in the process of placing the movie order, the user is recognized. Based on the recognition, the exemplary embodiment identifies target information to present to the user 18. In this embodiment, the target information may be identified from the target information stored for the user. For example, the exemplary embodiment may identify one or more advertisements specifically tailored to the user for presentation to the user while he or she watches the ordered movie. In action 20, the exemplary embodiment causes the assembly of customized information by causing the association of the identified target information with the requested information. For example, the exemplary embodiment causes the advertisements selected for the user to be played to the user while he or she watches the movie. The process ends in action 22.

The exemplary embodiments of the inventions operate generally in association with media players including set top boxes and the like that may be communicatively connected to other media players as well as other devices and endpoints in or connected to a communications network such as the Internet or other network. Moreover, an exemplary embodiment of the inventions may be embodied in a computer readable medium having computer executable instructions. For example, an exemplary embodiment may be an application computer program or an applet.

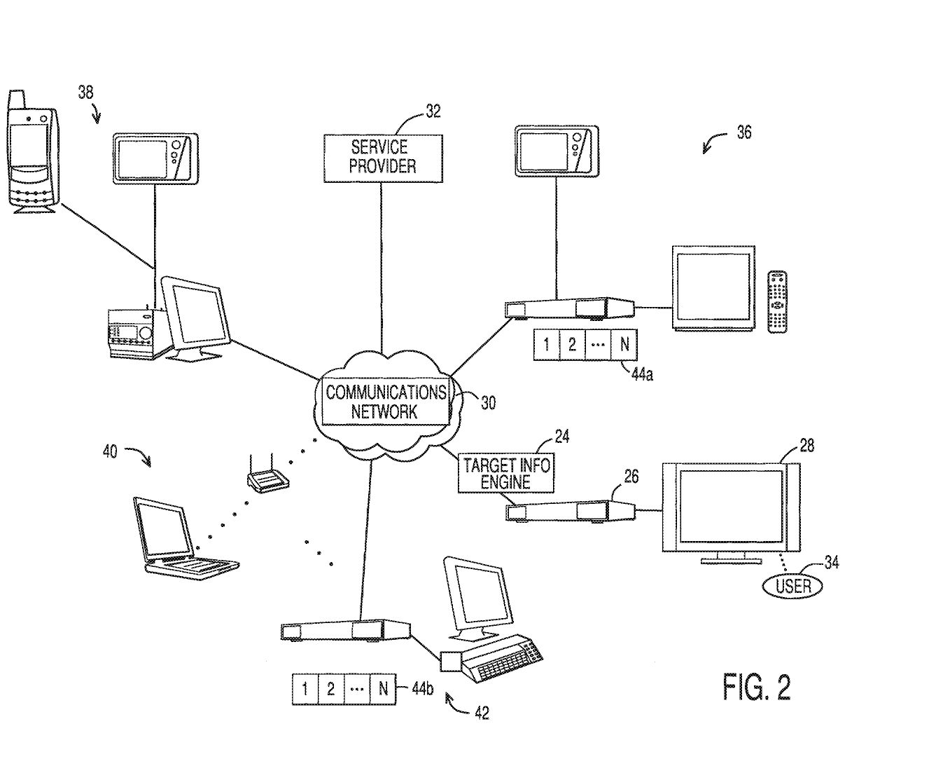

FIG. 2 and the following discussion are intended to provide a brief, general description of a suitable environment in which the inventions may be implemented. The inventions are described in the general context of an applet that may be run from an application program that may be run on a media player such as a digital set top box (having a browser for Internet or other networking capability). Those skilled in the art will recognize that the inventions also may be implemented in or in combination with other program modules. Generally, program modules include routines, programs, components, data structures, etc. that perform particular tasks or implement particular abstract data types.

Moreover, those skilled in the art will appreciate that the inventions may be practiced with other element or system configurations, including hand-held devices such as personal digital assistants (PDAs), digital audio players, cameras, wireless units including mobile telephones and pagers, personal computers, multiprocessor systems, microprocessor-based or programmable consumer electronics, minicomputers, mainframe computers, and the like. The inventions may also be practiced in distributed computing environments where tasks are performed by remote processing devices that are linked through a communications network. In a distributed computing environment, program modules may be located in both local and remote memory storage devices. Further information regarding such alternative or additional elements or systems may be found in the Agrawal et al., published patent application, Pub. No. U.S.2002/0129055A1, which is incorporated herein by reference.

FIG. 2 illustrates an exemplary embodiment of the inventions embodied as an applet referred to herein as a target information (“info”) engine 24 and that may be a part of or otherwise connected to the set top box 26, which in turn may be connected to a presentation device such as a television 28. A presentation device also may be referred to as a display device, and as its name implies, may function to display or present information such as a television including a television picture tube, a cathode ray tube (CRT) or a flat-panel display, a projection screen or display, a computer screen or display. The exemplary target information engine 24 as part of the set top box 26 or otherwise may be communicatively connected to and used at substantially the same time in connection with more than the one presentation device 28 illustrated in FIG. 2. For example, users in different parts of a house may be using respectively different (or even the same type of) presentation devices, and the exemplary invention may operate with all of them.

Through the set top box 26, the target information engine 24 is connected through a communications network 30 such as the Internet to a service provider 32. For purposes of illustration, the exemplary target information engine 24 is illustrated outside but connected to the set top box 26, but typically would be included as a part of the set top box 26.

In particular, the set top box 26 preferably includes a controller board including a central processing unit(s), a memory such as a semiconductor random access memory (RAM), a cache memory, and connections to peripheral units. The set top box 26 may include a removable (internal or external) hard disk drive, and a read only memory (ROM). In addition, the set top box includes an operating system and an application layer preferably with executable programs stored on the hard disk drive. The set top box 26 further may include interface boards for connection to the Internet, the public switched telephone network, cable TV, etc. A set top box as may be configured to operate with the inventions is described in the Sheekookian patent, U.S. Pat. No. 6,971,120, which is incorporated herein by reference. Other configurations of set top boxes may be used.

As noted, the exemplary target information engine 24 is connected through set top box 26 the communications network 30 to the service provider 32. A single service provider is illustrated, but the inventions should not be so limited. One or more service providers may provide a user 34 access to media, entertainment, information, communications, education, and/or other services over the communications network 30 to the user 34. Further, the inventions are described herein in connection with a user's subscription to a service provider 32 for services. The inventions, however, should not be so limited. A user does not necessarily have to subscribe to services, but may obtain them in other ways by pay per use, or otherwise. The inventions do not have to be associated exclusively with only a single or even any service provider. There may be ways to configure the exemplary target information engine to operate without a service provider.

The illustrated embodiment refers to only a single user 34, but the inventions should not be so limited. Advantageously, profile information on each of a plurality of users may be accumulated and used to provide target information tailored individually for each user.

In the exemplary embodiment, when the user 34 subscribes to services from the service provider 32, the user 34 may provide profile information such as identity information including name, address, age, gender, race, ethnicity as well as interest information such as hobbies, sports interests, media interests, and other information. This profile information may be used to compile the target information for that particular user. Moreover, information in the profile information may be weighted with respect to the manner in which the profile information is used to compile the target information. The weighting may be made to vary depending upon circumstances. For example, a user's gender may be weighted higher than his or her age or other characteristics in the profile information.

Further, special profile information may be compiled, stored and used with the exemplary target information engine 24 for use in different situations relating to a user or group of users. For example, a group of users such as a group of fans interested in a particular professional football team may set up special profile information tailored to the group's interests. When the group of fans gathers to watch their choice of events, the exemplary target information engine 24 uses the special profile information to cause the presentation of target information tailored for the group and/or for their choice of event. The special profile information may be compiled, stored, and used for a single event such as a viewing of an event like the Superbowl, and/or may be compiled, stored, and used for a recurring event like a weekly professional football game. Hereinafter, reference to profile information also refers to special profile information unless otherwise specified.

The profile information may be stored by the target information engine 24, the set top box 26, other peripheral device, and/or by the service provider 32. The user 34 and/or group of users may change profile information, which in turn may result in a change in the target information.

Based on the profile information, the exemplary target information engine 24 causes the identification of target information for the user 34 (or group or other users as appropriate). The exemplary target information is based substantially on the profile information relating to the user 34. For example, a user interested in sports may have advertisements on sporting events, sports equipment, sports games, etc. identified as target information for that user. A group of users whose profile information identifies a common interest such as classical music may have information on classical music concerts, instruments, and the like identified as target information for the group of users.

The identified target information (or parts thereof) may be stored after identification in association with or at the target information engine 24, the set top box 26, and/or the service provider 32 or otherwise. Alternatively, the identified target information (or parts thereof) may be obtained at a later time after identification such as when necessary to be inserted into the requested information so as to provide the user with customized information.

In addition to the profile information of the user, the target information may be accumulated based on other factors such as the choice made by the user for viewing or listening or participation. As an example, assume a user interested in sports is detected as tuning into the annual Superbowl game. Based on the user's interest in sports and based on tuning into the annual Superbowl game, the user may be presented with information on previous Superbowl games, on the specific characteristics of the current teams in the game, on other sporting events in the city where the Superbowl is being held as well as advertisements tailored to the user's watching of the game. For example, the user may be shown advertisements relating to food and drink that may urge the user to consume such food and drink during the Superbowl game.

Other factors that may be taken into account when identifying target information are provided at the end of this description when other alternatives are also provided.

In the exemplary embodiment, the target information engine 24 may identify and/or accumulate or cause the accumulation of the target information by communicating with the service provider 32. The target information may be provided to the target information engine 24 by the service provider 32. Information on the location of the target information may be obtained from or provided to the target information engine 24 by the service provider 32. Further, the service provider 32 may cause the target information to be provided to the target information engine 24. The target information may be accumulated in whole and/or in part in the ways mentioned or otherwise. For example, the service provider 32 may cause an advertisement to be provided in respective parts by other network elements to the target information engine 24. The manner of this transmission of respective parts of the advertisement from other network elements, advantageously, may be made in a peer to peer manner to the exemplary target information engine 24.

In alternative embodiments, the target information engine 24 may identify and/or accumulate or cause the accumulation of the target information in other ways such as by obtaining the target information from a site on the Internet or otherwise.

The identified target information may be stored by the exemplary target information engine 24 and/or caused to be stored in an accessible fashion to the target information engine 24 by the set top box 26 and/or otherwise. In addition or in the alternative, the target information engine 24 may obtain the target information from the service provider 32 and/or other network elements and/or otherwise as needed for presentation to the user including the peer to peer manner of communication referenced above.

The exemplary target information engine 24 may update, change, add to or otherwise affect the content of the stored target information. For example, the target information engine 24 may store target information relating substantially to a user's profile, but then may add, substitute, or otherwise update the target information in whole or in part based on other factors such as what the user is watching, listening to, participating in, current events, demographics, etc. The addition, substitution, updating or other effect on the target information may be carried out at the time the user's use is first detected, and/or at periodic intervals during the user's use, at any time during the user's use, and/or at other times.

Advantageously, the exemplary target information engine 24 recognizes the user 34 when the user 34 makes a request for information such as a request to the service provider 32 for a movie or other entertainment services, for information, for educational services, etc. The target information engine 24 generally recognizes the user 34 based on a comparison of the user's log-in for services to the profile information stored for the user 34.

The target information engine 24 may be made aware of or obtain information about events and facts other than a user's request for information. The target information engine 24 may be provided with or obtain information about the information being presented to the user, and/or about events relating to the user's interaction with the presentation. The target information engine 24 may make use of this information in relation to the target information that may be presented to the user 34. For example, the target information engine 24 may be provided with or obtain information regarding a user's watching of the Superbowl. In response, the target information engine 24 may identify, store, and/or cause target information relating to the user and to the Superbowl to be shown to the user. As another example, the target information engine 24 may be provided with or obtain information that the user has paused a movie he or she was watching. The target information engine 24 may identify or obtain target information relating to that movie such as a trailer for a sequel. Upon the user's return to watching the movie, the target information engine may cause the trailer for the sequel to be presented to the user.

Once the target information engine 24 has recognized the user, the target information engine 24 may identify specific target information for the user. Typically, this specific target information is identified from the target information already identified and/or accumulated for the user 34, and/or may be obtained at the time of the user's log-in and/or at other times. In some cases, the specific target information may be the previously identified and/or accumulated target information.

Once the specific target information is identified, and obtained, if necessary, the target information engine 24 causes the specific target information to be assembled in association with the requested information. Advantageously, the assembly of the specific target information with the requested information customizes the information for the user.

FIG. 2 illustrates exemplary other groups of elements 36, 38, 40 and 42 besides the user 34 and his or her target information engine 24, set top box 26, and presentation device 28. These groups of elements 36, 38, 40 and 42 are illustrated as connected to the communications network 30 and may be employed by other users in obtaining services from service provider 32. In addition, these groups of elements 36, 38, 40 and 42 may facilitate the assembly of the customized information described above. This facilitation may occur as the result of the peer to peer communications that may take place among the elements.

In particular, each of these groups 36, 38, 40 and 42 includes a set top box, media player, or similar device for use in obtaining services from the service provider 32 for respective users. Assume the respective users in groups 36 and 42 have requested and been provided with a particular movie 44a, 44b. When user 34 makes a request of the service provider 32 for that particular movie, the service provider 32 may cause the particular movie to be provided in part or parts to the user 34 in peer to peer communications from the users 36 and 42, who had earlier been provided the particular movie 44a, 44b. A copy of part(s) of the particular movie or part(s) of the particular move provided to the users 36 and 42 may be provided.

The provision of the particular movie in part(s) to the user 34 may be carried out in a number of ways. The service provider 32 may respond to the user's request for the particular movie by providing the target information engine 24 of the user 34 with information on the location of the part(s) of the particular movie 44a, 44b. The service provider 32 may provide direction on which part or parts of the particular movie 44a, 44b to obtain from which source, or that direction may be left to the target information engine 24, and/or to the sources. The user's target information engine 24 through its set top box 26 may communicate directly in a peer to peer manner with the appropriate elements of the other groups 36 and 42 to obtain the part(s) of the particular movie 44a, 44b. Alternatively, the service provider 32 may provide instructions to the appropriate elements of the groups 36 and 42 having the particular movie to send it (and/or part or parts thereof) to the target information engine 24 of the user 34.

The exemplary embodiment is described with reference to the assembly of requested information from part(s) received in a peer to peer manner from other elements that may be part of the relevant communications network. The inventions should not be so limited. The requested information may be received in other ways including receipt in whole or in part from the service provider and/or other entities.

Upon receipt of the respective part(s) of the requested information such as the particular movie from other groups of elements 36, 42, the requested information is assembled and presented to the user 34. As noted above, the requested information is assembled with the specific target information so as to present customized information to the user 34. Specifically, the customized information is assembled by inclusion of specific target information at one or more insertion points in the requested information.

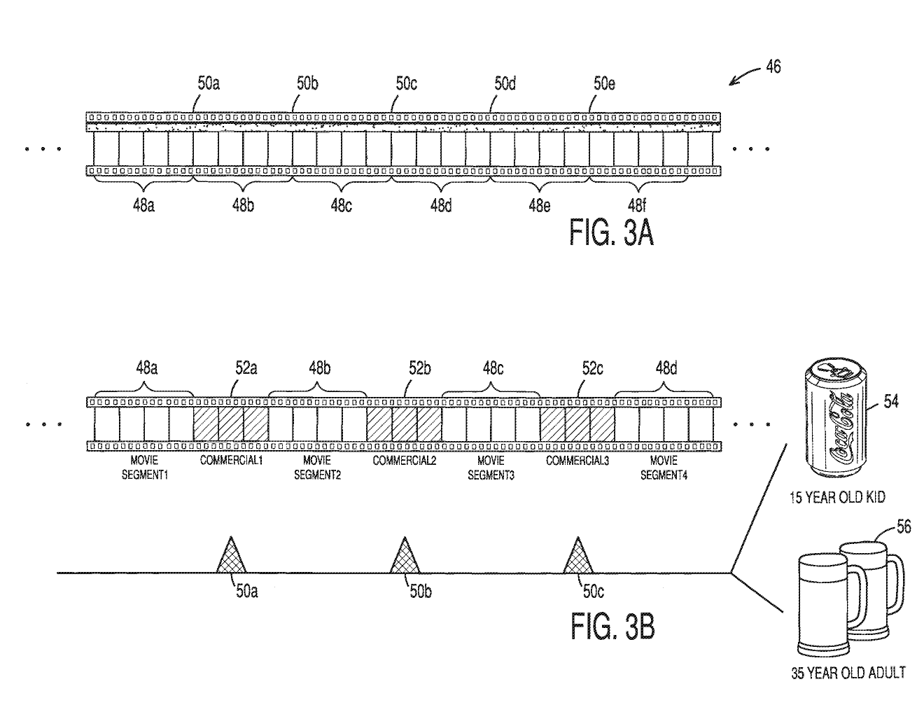

FIG. 3 illustrates a representation 46 of requested information such as a movie with divisions (also referred to as parts) 48a-f between insertion points 50a-e. In this example, the insertion points 50a-e appear to be regularly spaced between divisions of the same general size, but that does not have to be the case. An insertion point may be marked generally anywhere in requested information. A marker such as may be conventionally used for the insertion of a commercial in a television broadcast may be a type of or recognized as an insertion point for target information. An insertion point may be time driven such as being included an hour into a presentation, 90 minutes into the presentation, etc. An insertion point may be event driven such as being inserted upon the pausing of the viewing of the presentation by the user, the starting the presentation, etc., or a combination of the above.

An insertion point or points may be included in information that may become requested information by the service provider 32, or by other elements such as the target information engine 24. However inserted, the target information engine 24 recognizes the insertion point(s) and inserts and/or causes specific target information to be inserted at those points. FIG. 3B illustrates the representation 46 of FIG. 3A with the divisions 48-d as movie segments, and with commercials 52a-c included respectively at insertion points 50a-c. The illustrations refer to three different commercials 52a-c, but they may be the same commercial, may be other types of information such as public service announcements, and/or other information. Also, the illustrations make the commercials 52a-c appear to be the same size, but that does not have to be case.

The target information engine 24 may insert or cause the insertion of the specific target information at the insertion points by obtaining the specific target information from target information previously identified and accumulated whether stored at the target information engine 24, the set top box 26, the service provider 32, or otherwise. Alternatively, the target information engine 24 may obtain the specific target information in a manner similar to the peer to peer method of communications with other elements connected to the network 30 as described above in connection with obtaining part(s) of a particular movie 44a, 44b. In other words, part(s) of the specific target information may obtained respectively from other elements in the network 30 through use of peer to peer communications. As noted with reference to obtaining part(s) of the particular movie 44a, 44b, the target information engine 24 may communicate with the service provider 32 to request that specific target information be provided, to request locations for part(s) of the specific target information, or otherwise to carry out obtaining the specific target information in a peer to peer manner.

FIG. 3B also illustrates a particular advantage of the inventions in that they allow for specific target information tailored to a specific user to be presented with information requested by the user. Advantageously, the specific target information may be tailored to the information requested as well as to the user or based on other factors. Referring to FIG. 3B, assume the case of two different users 54, 56 requesting to be presented the Superbowl. Target information for the Superbowl may include beverage advertisements. Assume the first user 54 is a fifteen year old teenager and that age information is present in the user's profile. Based on the user's age and the request for presentation of the Superbowl, the specific target information may be advertisement(s) for soft drinks, which may be inserted at insertion points during the Superbowl. Assume the other user 56 is a thirty-five year old adult. Based on the user's status as an adult and the request for presentation of the Superbowl, the target information may be advertisement(s) for beer. Thus, the same request for information may result in different presentations of customized information based on characteristics of the user making the request.

The above examples are simplified for purposes of explanation. In addition to a user's age, other features and characteristics of the user may be used to present target information. In some cases, a user's profile may not come into play in presenting target information to the user. Moreover, a selected user's characteristic from a profile may be used to choose a first target to be used as target information, and the same and/or other characteristic(s) from the profile may be used to choose a second or other target to be used as target information. For example, a selected user's gender may result in an advertisement for a sporting event as a first target, and the selected user's age may result in an advertisement for a soft drink as a second target.

The exemplary target information engine 24 also may use, or may use instead, factors other than the user's profile with respect to choosing target information. Time, day of the week, season, current events, and other items also may influence the choice of target information. For example, during unseasonable weather, the target information engine 24 may present weather updates in the interests of public safety as the target information without regard to the profile information of the user. As another example, the target information engine 24 may combine a factor or factors selected from the user's profile in combination with other information to select target information. The same movie presented to the same user at different times of the day may include different target information. Food may be advertised during lunch and the dinner hour while other types of information may be provided at other times of the day.

Alternative embodiments may allow a user to select fewer or more or even no insertion points for target information. For example, a user may pay less for service from the service provider if he or she agrees to more insertion points and therefore more target information inserted in requested information. The user may pay a premium for requested information with no insertion points and no target information. In contrast, the user may not have to pay or not pay much for requested information that is essentially “all” or mostly target information. The user may be able to select his or her preference for target information on a request by request basis, or the user may subscribe to a certain amount of target information during each presentation of requested information over a period of subscription. In an embodiment, the user may be able to change the basis relating to the number of insertion points and/or payment of fees for service during presentation of requested information. For example, if a football game is in its final minutes and the score is tied, a user may be able to change his or her basis so that no target information is shown during the last few minutes. This change may or may not result in a charge to the user.

The size and placement of the specific target information also may be made to vary in an exemplary embodiment. For example, a user may choose to have specific target information appear in a manner similar to a banner advertisement without interruption to the requested information. As another example, a user may save on subscription fees if he or she allows specific target information to occupy all or most of the presentation display used for viewing the requested information.

Another alternative may allow a user to select how much profile information to provide. The user may pay a premium to provide only minimal profile information. The user may pay less the more information he or she provides. The more profile information that is provided, the more is known about the user and his or her habits and other characteristics, and the more specific and tailored the target information can be.

The exemplary embodiment is described with reference to a user or subscriber providing profile information. The source for profile information, however, may be other than the user or subscriber. For example, information on a user may be obtained from public records, marketing lists, etc.

Other alternatives may allow for a preference of insertion of target information based on fees paid to the service provider by advertisers or others desiring to insert target information at particular places in requested presentations or at certain times of the day. For example, a political campaign may pay a premium to have a campaign advertisement presented as a first target in target information inserted into information requested by a user whose profile the political campaign would like to target. In this case, the target information engine 24 may use the profile of the user 34 as well as the characteristics of the requested information in combination with information on target information preferences and premiums paid by advertisers to position the campaign advertisement as the first target of the target information assembled with the requested information into the information customized for the user.

The inventions have been described by reference to exemplary embodiments, but many additions, modifications, and/or deletions can be made thereto without departing from the spirit and scope of the inventions. In other words, the particular embodiments of the inventions described herein are merely illustrative and are not the only embodiments possible. Those skilled in the art can readily identify additional embodiments and features of the inventions that are within the spirit and scope of the inventions.

I claim:

1. A method for presenting customized information to a user, comprising:
recognizing the user making a request for information;
identifying target information for the user; and
causing the assembly of the customized information by causing the association of the target information with the requested information,
whereby the requested information with the associated target information is presented to the user as the customized information.

2. The method of claim 1, wherein identifying the target information for the user comprises identifying the target information based on a profile of the user.

3. The method of claim 1, wherein identifying the target information for the user comprises identifying the target information for the user based on the information requested by the user.

4. The method of claim 1, wherein identifying the target information for the user comprises identifying the target information for the user based on a profile of the user and on the information requested by the user.

5. The method of claim 1, wherein the target information comprises a first target and a second target;
wherein the requested information comprises a first element and a second element; and
wherein assembling the customized information comprises associating the first target with the first element and associating the second target with the second element.

6. The method of claim 1, wherein causing the assembly of the customized information by causing the association of the target information with the requested information comprises causing the insertion of the target information into an insertion point of the requested information.

7. The method of claim 6, wherein the requested information comprises parts respectively received from two or more sources;
wherein the insertion point of the requested information comprises a point between two parts of the requested information; and
wherein causing the assembly of the customized information by causing the association of the target information with the requested information comprises causing the insertion of the target information between the two parts of the requested information.

8. The method of claim 7, wherein the two parts of the requested information are sequential; and wherein causing the insertion of the target information between the two parts of the requested information comprises causing the insertion of the target information between the two sequential parts of the requested information.

9. The method of claim 6, wherein the insertion point comprises a marker in the requested information; and
wherein causing the insertion of the target information into the insertion point comprises causing the insertion of the target information at the marker in the requested information.

10. The method of claim 6, wherein causing the insertion of the target information into the insertion point of the requested information comprises causing the insertion based on a time code.

11. The method of claim 6, wherein causing the insertion of the target information into the insertion point of the requested information comprises causing the insertion based on an event code.

12. The method of claim 1, further comprising:
storing the target information of the user.

13. The method of claim 1, wherein identifying target information for the user comprises determining locations of a respective part or parts constituting the target information; and
wherein causing the assembly of the customized information comprises causing transfer from the locations of the respective part or parts constituting the target information, and causing the association of the target information with the requested information.

14. A computer readable medium having computer executable instructions for performing the actions in claim 1.

15. In a media presentation system being used by more than one user, a method for presenting information requested by a user plus information targeted to the user, comprising:
storing target information for each of the users;
determining either the first user or the second user is an information requestor;
determining target information for the information requestor;
obtaining the requested information in parts from peer sources; and
inserting the target information for the information requestor at an insertion point of the requested information,
whereby the requested information is presented as well as the target information for the information requestor.
